(19) United States
(12) Patent Application Publication
(10) Pub. No.: US 2025/0171154 A1
(43) Pub. Date: May 29, 2025

(54) AIRCRAFT WITH MULTI-POWER SOURCE ELECTRIC PROPULSION SYSTEM

(71) Applicant: Korea Aerospace Research Institute, Daejeon (KR)

(72) Inventor: JaeSung HUH, Daejeon (KR)

(73) Assignee: Korea Aerospace Research Institute, Daejeon (KR)

(21) Appl. No.: 18/951,988

(22) Filed: Nov. 19, 2024

(30) Foreign Application Priority Data
Nov. 28, 2023 (KR) 10-2023-0167634

(51) Int. Cl. B64D 27/33; B64D 27/355; B64D 27/357; B64D 33/08

(52) U.S. Cl. CPC B64D 27/33; B64D 27/355; B64D 27/357; B64D 33/08

(57) ABSTRACT

Provided is an aircraft with a multi-power source electric propulsion system. The aircraft includes a fuselage, a power turbine accommodated in the fuselage and having a power shaft, a generator accommodated in the fuselage and connected to one end of the power shaft, a forward propeller for a forward flight and connected to another end of the power shaft, and a lift propeller for vertical take-off and landing (VTOL) and configured to receive power from the generator.

### CROSS-REFERENCE TO RELATED APPLICATIONS

This application claims the benefit of Korean Patent Application No. 10-2023-0167634, filed on Nov. 28, 2023, in the Korean Intellectual Property Office, the entire disclosure of which is incorporated herein by reference for all purposes

### BACKGROUND

### Field of the Invention

One or more embodiments relate to an aircraft, and more particularly, to an aircraft with a multi-power source electric propulsion system.

### 2. Description of the Related Art

A vertical take-off and landing (VTOL) aircraft and/or vehicle is considered as a core element of urban air mobility (UAM), which is an urban transportation system that transports people and cargo using an aircraft and/or vehicle. A VTOL aircraft/vehicle is an aircraft that may operate even in an urban environment where it is difficult to build a runway and is emerging as a three-dimensional (3D) future transportation method that may solve road traffic congestion and environmental problems due to the increase in urban population.

A VTOL aircraft and/or vehicle has a characteristic of a fixed-wing aircraft during a flight and a characteristic of a rotary-wing aircraft during take-off and landing by combining a fixed wing with a rotary wing, requires the minimum runway when taking off and landing, and may take off, ascend, or descend vertically.

In particular, an electric VTOL (eVTOL) aircraft and/or vehicle is at the core of an advanced air mobility (AAM) ecosystem. The demand for eVTOL development is increasing as expertise in building a scalable air system and vision for mobility are integrated.

A radiator used in an aircraft and/or vehicle is a heat exchanger used to transfer heat energy from one medium to another for the purpose of cooling and heat dissipation. The radiator is one of the devices in a system that maintains a constant operating temperature of components, such as an engine, etc., and may serve as a key heat exchange role. As a power level of an electric propulsion system in an aircraft and/or vehicle increases, air-cooling or water-cooling is being applied.

PCT International Publication No. 2015/046785 A1 discloses an unmanned aircraft launching device for launching the unmanned aircraft.

The above description has been possessed or acquired by the inventor(s) in the course of conceiving the present disclosure and is not necessarily an art publicly known before the present application is filed.

### SUMMARY

Embodiments provide an aircraft with a multi-power source electric propulsion system that is an electric vertical take-off and landing (eVTOL) aircraft capable of flying in an urban area.

Embodiments provide an aircraft with a multi-power source electric propulsion system that may increase the utilization of urban air traffic using both an advantage of a fixed-wing aircraft having high flight efficiency and a function of a multi-copter capable of vertical take-off and landing (VTOL).

Embodiments provide an aircraft with a multi-power source electric propulsion system that has sufficient energy capacity of batteries to have fewer constraints on the flight distance and/or time and payload.

Embodiments provide an aircraft with a multi-power source electric propulsion system that is eco-friendly and has improved stability due to ease of handling failures by securing redundancy.

According to an aspect, there is provided an aircraft with a multi-power source electric propulsion system, the aircraft including a fuselage, a power turbine accommodated in the fuselage and having a power shaft, a generator accommodated in the fuselage and connected to one end of the power shaft, a forward propeller for a forward flight and connected to another end of the power shaft, and a lift propeller for VTOL and configured to receive power from the generator.

The aircraft may further include a controller configured to control a power distribution to the generator and the forward propeller. The controller, in a forward mode, may be configured to adjust a pitch angle of the forward propeller to a first angle and configured to adjust a rotation speed of the power shaft to a first rotation speed, and the controller, in a power generation mode, may be configured to adjust the pitch angle of the forward propeller to a second angle and configured to adjust the rotation speed of the power shaft to a second rotation speed, in which the first angle may be greater than the second angle, and the first rotation speed may be less than the second rotation speed.

The aircraft may further include a gearbox disposed between the forward propeller and the power turbine.

The aircraft may further include a radiator configured to cool a motor driving the lift propeller, in which a radiator cover for air inflow may be provided in front of or above the radiator, and the radiator cover may be opened by pressure of inflowing air when a speed of the lift propeller is greater than or equal to a preset speed.

The aircraft may further include a heat exchanger configured to cool the generator, the gearbox, and the power turbine, in which the heat exchanger may include a liquid cooling source, and the liquid cooling source may be configured to circulate in order of a rectifier, the generator, the gearbox, and the power turbine.

The liquid cooling source passing through the power turbine may be cooled through heat exchange with fuel of the power turbine in a fuel tank of the power turbine.

The aircraft may further include a battery package configured to supply power to a lift propeller and a hydrogen fuel cell package configured to supply the power to the forward propeller.

The hydrogen fuel cell package may be disposed at the rear of the aircraft, and the battery package may be disposed at the bottom of the aircraft.

The aircraft may further include a hydrogen fuel cell heat exchanger configured to control heat management of the hydrogen fuel cell package, in which the hydrogen fuel cell heat exchanger may be disposed at the rear of the aircraft to be adjacent to the hydrogen fuel cell package.

Additional aspects of embodiments will be set forth in part in the description which follows and, in part, will be apparent from the description, or may be learned by practice of the disclosure.

According to embodiments, an aircraft with a multi-power source electric propulsion system may be provided as an electric vertical take-off and landing (eVTOL) aircraft capable of flying in an urban area.

According to an embodiment, an aircraft with a multi-power source electric propulsion system may increase the utilization of urban air traffic using both an advantage of a fixed-wing aircraft having high flight efficiency and a function of a multi-copter capable of VTOL.

According to an embodiment, an aircraft with a multi-power source electric propulsion system may obtain an advantage of having fewer constraints on the flight distance and/or time and payload by sufficiently securing the energy capacity of batteries.

According to an embodiment, an aircraft with a multi-power source electric propulsion system may easily handle failures by securing redundancy, thereby improving stability and being eco-friendly.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a first embodiment of an electric propulsion system of an aircraft with a multi-power source electric propulsion system, according to an embodiment; and

FIG. 2 is a diagram illustrating a second embodiment of an electric propulsion system of an aircraft with a multi-power source electric propulsion system, according to an embodiment.

### DETAILED DESCRIPTION

Hereinafter, embodiments will be described in detail with reference to the accompanying drawings. However, various alterations and modifications may be made to the embodiments, and thus, the embodiments are not construed as limiting the scope of the rights of the patent application. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

The same name may be used to describe an element included in the embodiments described above and an element having a common function. Unless otherwise mentioned, the descriptions on the embodiments may be applicable to the following embodiments and thus, duplicated descriptions will be omitted for conciseness.

Hereinbelow, embodiments of the disclosure will be described in detail with reference to the accompanying drawings so that the embodiments may be readily implemented by one of ordinary skill in the technical field to which the disclosure pertains. However, the present disclosure may be implemented in many different forms and is not limited to the embodiments described herein. Also, parts irrelevant to the description are omitted from the drawings for a clear description of the disclosure.

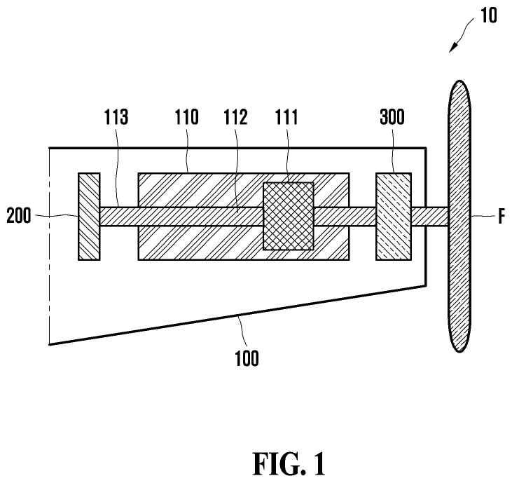

FIG. 1 is a diagram illustrating a first embodiment of an electric propulsion system of an aircraft 10 with a multi-power source electric propulsion system, according to an embodiment.

Referring to FIG. 1, according to an embodiment, the aircraft 10 with a multi-power source electric propulsion system may include a fuselage 100, a power turbine 111 accommodated in the fuselage 100 and having a power shaft 112, a generator 200 accommodated in the fuselage 100 and connected to one end 113 of the power shaft 112, and a gearbox 300 disposed between a forward propeller F and the power turbine 111.

In addition, according to an embodiment, the aircraft 10 with a multi-power source electric propulsion system may include the forward propeller F for a forward flight and connected to the other end of the power shaft 112 and a lift propeller (not shown) for vertical take-off and landing (VTOL) and configured to receive power from the generator 200.

For example, according to an embodiment, the aircraft 10 with a multi-power source electric propulsion system may include a gas turbine engine-based hybrid electric propulsion system. As shown in FIG. 1, an engine 110 may include the power turbine 111 therein. For example, the engine 110 may be a gas turbine engine. The engine 110 may generate power by converting energy, which is generated by compressing gas with a compression turbine (not shown) and combusting or exploding the gas with fuel in a combustion chamber (not shown), into kinetic energy through the power turbine 111.

Referring to FIG. 1, the power shaft 112 may cross the engine 110 in a horizontal direction, and the other end of the power shaft 112 may pass through the gearbox 300 and be connected to the forward propeller F outside the engine 110. In the engine 110, the power turbine 111 may be provided in the power shaft 112, and the forward propeller F may be driven by driving the power shaft 112.

The one end 113 of the power shaft 112 may be connected to the generator 200 in a direction that is opposite to the horizontal direction from the forward propeller F. Through the generator 200, mechanical energy of the power shaft 112 may be converted into electricity, or mechanical energy from an external system may be converted into electricity so that electrical energy may be supplied to the driving of the power shaft 112. A rectifier may be provided in the generator 200, and current may flow in one direction through the rectifier.

The gearbox 300 connected to the other end of the power shaft 112 may be formed as, for example, a box-shaped frame with a built-in gear device used for electricity. Gears for power transmission that are required to rotate the power shaft 112 may be embedded in the gearbox 300. The gearbox 300 may transmit power to the forward propeller F through the engagement of the embedded gears.

Through the gearbox 300, a rotation speed of the forward propeller F may be adjusted, such as a deceleration of the rotation speed. In addition, a pitch control actuator that adjusts a pitch angle of the forward propeller F may be additionally provided in the forward propeller F.

For example, the aircraft 10 may further include a controller (not shown) that controls a power distribution to the forward propeller F and the generator 200. The controller of the aircraft 10 may control a rotation speed of the power turbine 111 or the pitch angle of the forward propeller F to achieve the power distribution to the forward propeller F and the generator 200.

The aircraft 10 may include a forward mode that requires more power of the forward propeller F and a power generation mode that requires more power of the generator 200 than that of the forward propeller F. Hereinafter, an operating method of the controller in the forward mode and the power generation mode is described.

In the forward mode, the controller may adjust the pitch angle of the forward propeller F to a larger angle and adjust the rotation speed of the power shaft 112 to a lower speed. The controller may adjust the rotation speed of the power turbine 111 driving the power shaft 112 to a lower speed.

In the power generation mode, the controller may adjust the pitch angle of the forward propeller F to a smaller angle and adjust the rotation speed of the power shaft 112 to a higher speed. That is, the controller may adjust the rotation speed of the power turbine 111 driving the power shaft 112 to a higher speed.

As described above, in the forward mode, the controller may adjust the pitch angle of the forward propeller F to a first angle and adjust the rotation speed of the power shaft 112 to a first rotation speed. In the power generation mode, the controller may adjust the pitch angle of the forward propeller F to a second angle and adjust the rotation speed of the power shaft 112 to a second rotation speed. Here, the first angle may be greater than the second angle, and the first rotation speed may be less than the second rotation speed.

For example, the aircraft 10 may further include a radiator (not shown) configured to cool a motor driving the lift propeller. The lift propeller for VTOL may use an electric engine, and the radiator may be used to cool the electric engine. The radiator may operate air-cooled or water-cooled. For example, the radiator may be positioned in a pod, and the pod may be mounted outside the aircraft 10 and formed in a cylindrical shape or box shape.

A radiator cover for air inflow may be provided in front of or above the radiator. As the aircraft 10 takes off and lands vertically, when the speed of the lift propeller becomes greater than or equal to a preset speed, the front or above the radiator cover may be opened by the pressure of inflowing air.

Referring to FIG. 1, the aircraft 10 may further include a heat exchanger (not shown) configured to cool the generator 200, the gearbox 300, and the engine 110. In an example, the heat exchanger may be a liquid-liquid heat exchanger and may include a liquid cooling source. Here, the liquid cooling source may be oil.

For example, the generator 200, the gearbox 300, and the engine 110 may have the same liquid cooling source. The power turbine 111 included in the engine 110 may also have the same liquid cooling source. The liquid cooling source may be configured to circulate in order of the rectifier, the generator 200, the gearbox 300, and the engine 110.

The liquid cooling source passing through the power turbine 111 may be cooled through heat exchange with fuel of the power turbine 111 in a fuel tank of the power turbine 111.

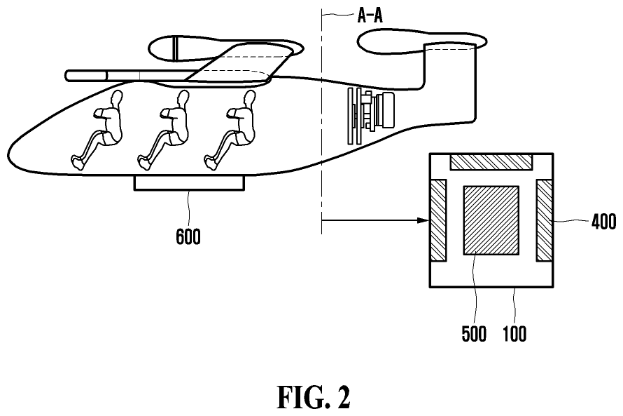

FIG. 2 is a diagram illustrating a second embodiment of the electric propulsion system of the aircraft 10 with a multi-power source electric propulsion system, according to an embodiment.

Referring to FIG. 2, the aircraft 10 may further include a battery package 600 configured to supply power to a lift propeller and a hydrogen fuel cell package 500 configured to supply the power to a forward propeller. In addition, the aircraft 10 may further include a hydrogen fuel cell heat exchanger 400 configured to cool the hydrogen fuel cell package 500.

For example, the aircraft 10 may include a hydrogen fuel cell hybrid electric propulsion system. For example, the aircraft 10 may include the second embodiment in addition to the first embodiment of the electric propulsion system described above. As described above, the aircraft 10 may be equipped with the generator 200 and the engine 110, such as a gas turbine engine, by connecting the generator 200 and the engine 110 to the power shaft 112 and may additionally be equipped with the hydrogen fuel cell package 500 and the battery package 600.

For example, as shown in FIG. 2, for the weight balance of the aircraft 10, the hydrogen fuel cell package 500 may be disposed at the rear of the aircraft 10, as indicated by line A-A in FIG. 2.

For example, the hydrogen fuel cell heat exchanger 400 may be disposed around the hydrogen fuel cell package 500 to control the cooling of a hydrogen fuel cell such as preventing cooling of the hydrogen fuel cell. For example, as shown in FIG. 2, the hydrogen fuel cell heat exchanger 400 may be disposed at the rear of the aircraft 10 to be adjacent to the hydrogen fuel cell package 500. As shown in the cross-section indicated by line A-A in FIG. 2, a plurality of hydrogen fuel cell heat exchangers 400 may be disposed in front or sides around the hydrogen fuel cell package 500.

The battery package 600 may be disposed at the bottom of the aircraft 10, as shown in FIG. 2. In another example, the battery package 600 may be disposed under the passenger seat, in front of the aircraft 10, or on the wing of the aircraft 10.

A ratio of the hydrogen fuel cell package 500 and the battery package 600 may be selected as follows.

The battery package 600 may be configured in order of a cell, which is a unit for collecting batteries, a module, and a pack. For example, the number of cells may be from tens to thousands. For example, the packs of the battery package 600 may be formed as a collection of power cells for high output.

For example, the battery package 600 may be designed to enable the take-off and landing of the aircraft 10 without a fuel cell pack. That is, the aircraft 10 may be driven only by the battery package 600 during takeoff and landing.

For example, the hydrogen fuel cell package 500 may be designed based on the cruise power of the aircraft 10 and may be designed to enable charging of the battery package 600 if needed.

For example, the hydrogen fuel cell heat exchanger 400 for heat management of the hydrogen fuel cell package 500 may be designed based on a cruise condition.

According to an embodiment, the aircraft 10 with a multi-power source electric propulsion system may increase the utilization of urban air traffic using both an advantage of a fixed-wing aircraft having high flight efficiency and a function of a multi-copter capable of VTOL and may have a system capable of operating a fixed-wing aircraft, even in an area without a runway.

In addition, according to an embodiment, the aircraft 10 with a multi-power source electric propulsion system may sufficiently secure the energy capacity of batteries.

According to an embodiment, a flight distance, duration of flight, and payload may stably increase by securing redundancy through the aircraft 10 with a multi-power source electric propulsion system.

Accordingly, according to an embodiment, the aircraft 10 with a multi-power source electric propulsion system may be presented as a method that may solve a short flight time and distance of flight of urban air traffic and may be of great help in the distribution of domestic urban air traffic.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. An aircraft with a multi-power source electric propulsion system, the aircraft comprising:
a fuselage;
a power turbine accommodated in the fuselage and having a power shaft;
a generator accommodated in the fuselage and connected to one end of the power shaft;
a forward propeller for a forward flight and connected to another end of the power shaft; and
a controller accommodated in the fuselage,
wherein the controller is configured to control a power distribution to the generator and the forward propeller.

2. The aircraft of claim 1, wherein
the controller, in a forward mode, is configured to adjust a pitch angle of the forward propeller to a first angle and configured to adjust a rotation speed of the power shaft to a first rotation speed, and
the controller, in a power generation mode, is configured to adjust the pitch angle of the forward propeller to a second angle and configured to adjust the rotation speed of the power shaft to a second rotation speed,
wherein the first angle is greater than the second angle, and the first rotation speed is less than the second rotation speed.

3. The aircraft of claim 1, further comprising:
a gearbox disposed between the forward propeller and the power turbine.

4. The aircraft of claim 1, further comprising:
a lift propeller for vertical take-off and landing (VTOL) and configured to receive power from the generator.

5. The aircraft of claim 4, further comprising:
a radiator configured to cool a motor driving the lift propeller,
wherein a radiator cover for air inflow is provided in front of or above the radiator, and the radiator cover is opened by pressure of inflowing air when a speed of the lift propeller is greater than or equal to a preset speed.

6. The aircraft of claim 3, further comprising:
a heat exchanger configured to cool the generator, the gearbox, and the power turbine,
wherein the heat exchanger comprises a liquid cooling source, and the liquid cooling source is configured to circulate in order of a rectifier, the generator, the gearbox, and the power turbine.

7. The aircraft of claim 6, wherein the liquid cooling source passing through the power turbine is cooled through heat exchange with fuel of the power turbine in a fuel tank of the power turbine.

8. The aircraft of claim 1, further comprising:
a battery package configured to supply power to a lift propeller; and
a hydrogen fuel cell package configured to supply power to the forward propeller.

9. The aircraft of claim 8, wherein
the hydrogen fuel cell package is disposed at a rear of the aircraft, and
the battery package is disposed at a bottom of the aircraft.

10. The aircraft of claim 9, further comprising:
a hydrogen fuel cell heat exchanger configured to control heat management of the hydrogen fuel cell package,
wherein the hydrogen fuel cell heat exchanger is disposed at the rear of the aircraft to be adjacent to the hydrogen fuel cell package.
